(19) United States
(12) Patent Application Publication
(10) Pub. No.: US 2002/0100051 A1
(43) Pub. Date: Jul. 25, 2002

(54) Home entertainment system

(76) Inventors: Paul Applewhite, Basingstoke (GB); John McLaren, Basingstoke (GB)

Correspondence Address: LEON D. ROSEN, FREILICH, HORNBAKER & ROSEN, 10960 Wilshire Boulevard, Suite 1220, Los Angeles, CA, 90024, US

(21) Appl. No.: 10/047,620

(22) Filed: Jan. 15, 2002

(30) Foreign Application Priority Data
Jan. 19, 2001 (GB) 0101436.4

(51) Int. Cl. H04N 7/18; H04N 7/173; H04N 7/16

(52) U.S. Cl. 725/80; 725/74; 725/106; 725/141

(57) ABSTRACT

A home entertainment system has a switching matrix having supply ports that are connected to a plurality of TV tuners and at least one video camera. Each TV tuner demodulates a high frequency carrier signal to provide a specific channel to a supply port. Control signals that change the channel output of each TV tuner are transmitted upstream from the supply port to a corresponding TV tuner. The switching matrix has consumer ports that connect to terminals with consumer devices such as TV monitors located in different rooms of the home, each terminal receiving a signal of baseband frequency (no demodulation required) that may represent a television channel or a camera view and each terminal having a control that delivers signals to the consumer port to select a TV channel or select the camera. The switching matrix enables different ports to be coupled together, so that, for example, a camera in baby's room can be coupled to a television monitor in another room. All of the TV tuners and the switching matrix are located in the hub that lies in one room of a home, while the monitors are in different rooms, and the distribution of signals around the system takes place at baseband frequencies.

### CROSS-REFERENCE TO RELATED APPLICATION

Applicant claims priority from British application GB 0101436.4 filed 19 Jan. 2001.

### BACKGROUND OF THE INVENTION

This invention relates to home entertainment and data systems, in which a number of consumer electronic devices are interconnected by the system. For example, consumer devices may include television sets, a VCR (video cassette recorder), a stereo system, a DVD player, a video game player, an Internet terminal device, and security cameras.

A television set used to be a simple device for users to set up and connect. However, numerous other consumer electronic devices may now be connected to a television set, which complicates the connections and which also may degrade the signal quality within a system. In particular, the video carrier signal from an antenna, cable television system, or satellite TV dish is a modulated high frequency signal of a frequency over 50 MHz. In the U.S., the lowest VHS broadcast signal is channel 2 with a frequency of 54 to 60 MHz. Each U.S. prior (not HDTV) color channel has a bandwidth of about 6 MHz. The highest definition proposed for high quality HDTV (high definition TV) has a bandwidth of about 30 MHz, so video baseband is almost always under 40 MHz. Carrier signals for HDTV are at a nominal frequency of well over 100 MHz.

A modulated carrier signal is conventionally carried by a coaxial cable because a coaxial cable has the required bandwidth capacity. The video carrier signal is demodulated by the tuner of a TV receiver to produce a video channel of baseband frequency (under 40 MHz) that is converted to a video image by the monitor portion of the television set. Baseband frequencies are less than 40 MHz, while video carrier frequencies are more than 50 MHz. A baseband signal which represents one TV channel, does not have to be demodulated for display on a monitor, while a carrier TV signal is normally modulated with many channels and must be demodulated to obtain a channel for display.

In the past, a VCR would be connected to a television set using a coaxial cable and connectors carrying the high frequency UHF or VHF signals. The VCR would demodulate the signal to enable the signal to be recorded. When the recorded signal was played, it would have be remodulated to UHF frequencies before being transferred to the TV set over a coaxial cable. These multiple conversions are a source of noise. The more recent use of RCA AV connectors enables baseband signals to be transmitted between TV and VCR's, which reduces the noise problem. However, coaxial cables carrying UHF signals are still used for providing multiple TV outlets in different rooms in a home. This requires wide band amplification of the frequencies of interest before their distribution around the home.

The physical connection of multiple devices in order to realize the full benefit of each component of a home entertainment system can be difficult, with a variety of types of connectors required for different devices.

### SUMMARY OF THE INVENTION

In accordance with one aspect of the present invention, a home entertainment system backbone is provided which includes a hub having a plurality of TV tuners which each receives a carrier signal (modulated and over 50 MHz) modulated by a plurality of video channels, wherein the output of each TV tuner is a baseband (under 40 MHz with the video channel not modulated) video signal. The hub includes a switching matrix which has supply ports where the matrix receives the outputs of the TV tuners, and outputs of security cameras, etc. and delivers control signals to such TV tuners, etc. to select a channel, etc. The switching matrix also has consumer ports from which video channel signals are delivered to a selected TV monitor in a room for viewing and where control signals such from a remote control in the room are delivered to the switching matrix to control a TV tuner, etc. The switching matrix enables different ports to be coupled together to transmit signals between the different ports.

The architecture of the system enables the hub to be provided with one or more video carrier signals, typically over a coaxial cable, from an ariel, cable system, or satellite dish. All of the TV tuners used by the entertainment system are in the hub, so the distribution signals around the system, representing the different video channels, can take place at baseband frequencies (under 40 MHz). The switching matrix enables video generating consumer devices such as video recorders to be positioned in one location, except for video cameras, while enabling the signals to be connected to any chosen terminal in the home. The remote control sensors in the different rooms enable the tuners to be controlled despite their location in the hub.

Preferably, twisted pair cabling is provided between each port and the hub. This is possible because all signals from the hub are at baseband frequencies (under 40 MHz). The cabling may comprise four twisted pairs, with one twisted pair allocated to remote control signaling, one twisted pair allocated to one channel of audio, one twisted pair allocated to another channel of audio, and one twisted pair allocated to video data. The cabling may comprise balanced twisted pair cabling, such as CAT5 cabling, and each port may comprise an RJ45 port.

The terminals are distributed around the home and all connections to the terminals can be the same, regardless of the type of device to be connected to the system. One or more supply ports may be used for security cameras, and the switching matrix then enables camera images to be selectively coupled to the television monitors in the system. The hub may include means for detecting an alarm signal on the camera signal inputs (e. g. if the camera is provided with a motion detector), and can provide such an alarm signal to a selected TV monitor.

The supply ports of the switching matrix are each connected to a particular baseband frequency source such as the output of a particular TV tuner. There may be more supply ports than TV tuners, security cameras, etc., which enables each source of signals (TV tuner, etc.) to be connected to a selected supply port that is connected a particular terminal in a room. The hub may include a switching arrangement for coupling a first supply port at which audio received, to multiple other consumer ports where audio outputs signals are delivered. In this way, audio such as music can routed to multiple speakers. The switching arrangement can include manual switches for manually connecting a particular supply port to a particular consumer port. The same cabling can be used for audio as for video.

The home entertainment system includes a plurality of TV tuners each receiving a UHF, VHF, or other high frequency (above 50 MHz) video-modulated carrier signal and each tuner demodulating the signal to baseband (under 40 MHz and not modulated to carry multiple video channels). The system includes a switching matrix having baseband inputs for consumer devices and for TV tuner signals, and baseband outputs, wherein the switching matrix enables the inputs to be selectively coupled to the outputs. The system further includes a processor for receiving control signals from the terminals to enable control of the TV tuners and to control the switching matrix to enable selected consumer devices to be coupled to selected terminals.

The novel features of the invention are set forth with particularity in the appended claims. The invention will be best understood from the following description when read in conjunction with the accompanying drawings.

### BRIEF DESCRIPTION OF THE DRAWINGS

FIG. 1 is a block diagram showing a home entertainment system of the present invention.

FIG. 2 is a diagram showing how said a TV set or monitor is connected to the system.

FIG. 3 is a block diagram which shows an additional audio distribution system for use with the home entertainment system of FIG. 1.

FIG. 4 is an isometric view showing how speakers are connected to the system.

FIG. 5 is a block diagram view showing how consumer devices within the system can be located at any desire location.

### DESCRIPTION OF THE PREFERRED EMBODIMENTS

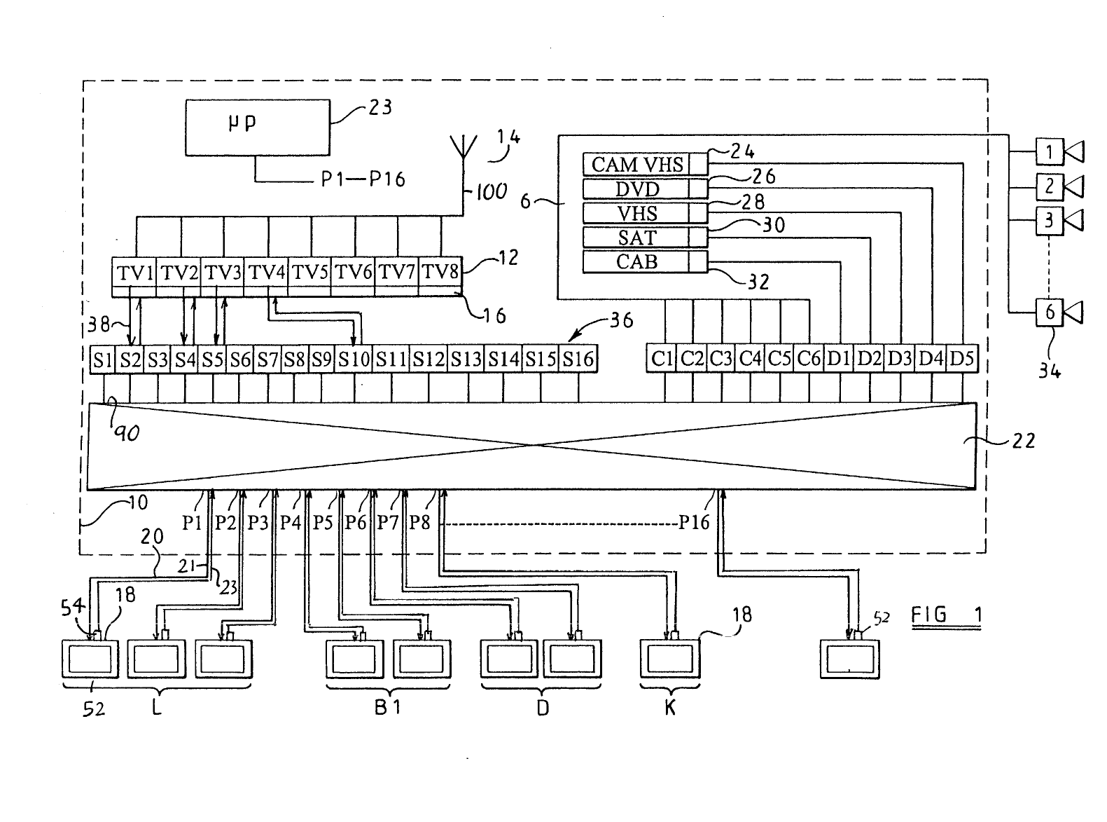

FIG. 1 illustrates shows a home entertainment system of the present invention, which includes a backbone, which is the essential wiring and connection terminals of the system and consumer devices connected to the terminals. The system has a central controlling hub 10 which comprises a plurality of TV tuners 12. In FIG. 1, eight of such tuners TV 1 to TV 8 are shown. The system can thus support eight independently controllable televisions or video monitors.

A source of video signals is indicated at 14, which may be a video cable, satellite dish receiver, video antenna or the like. The video carrier signal carried on line 100 may have a frequency of hundreds or thousands of megahertz, and be modulated by numerous video channels that each have a baseband frequency of less than 40 MHz. A baseband signal is a signal that can be viewed (or heard or contain digital data used, or otherwise used) without requiring demodulation and therefore without giving rise to extra noise that is created in demodulation.

The hub receives the high frequency modulated video (and audio, data, etc.) carrier signal input from source 14, and each tuner TV1 to TV8 demodulates the video carrier signal to produce a selected one of the multiple channels carried by the carrier signal, each channel being of baseband frequency (less than 40 MHz). Each tuner also has a stereo sound decoder, and provides a video output and audio left and right signals. Each tuner is also provided with a remote control signal reader, or channel changer device 16, which enables remote control signals to be provided to the tuners to control them by changing the tuner output to a different channel.

A plurality of room terminals 18 are provided, which are distributed around the home. Each piece of user equipment such as a TV set or monitor 52 for displaying a video signal and a controller 54 for changing channels, is connected to a terminal. It is noted that a TV set usually includes a TV tuner (demodulator) whose baseband output is delivered to a monitor-driving circuit. Applicant delivers baseband signals directly to the monitor-driving circuit, bypassing any tuner. In FIG. 1, the hub is shown as having sixteen consumer ports P1-P16 with corresponding output and input lines 21, 23 of a cable link or cabling 20. In the example shown, there are three TV monitors 52 and corresponding cable links 20 in the family room or lounge L, there are two in the master bedroom B1, two in the dining room D, and one in the kitchen K. There are also controllers 54 associated with some or all of the TV monitors.

Each room terminal 18 is connected to a consumer port P1-P16 of the hub by a cable link 20. Balanced twisted pair cabling is used, for carrying baseband (not UHF/VHF) signals. The cabling may comprise four twisted pairs, one pair allocated to remote control signaling, one pair allocated to one channel of audio, one pair allocated to another channel of audio, and one pair allocated to video signals. For example, the cabling may comprise CAT5 cabling, and each port may comprise an RJ45 socket.

The sixteen consumer ports P1 to P16 carry the output signals of the switching matrix 22 (plus input control signals). The switching matrix 22 is a baseband switching device (it carries signals under 40 MHz without modulation of video) which enables any of the inputs at the supply ports 90 (from the tuner devices TV1-TV8, VHS, cameras, etc.), to be switched to any of the outputs at the consumer ports P1-P16 using switches that switch baseband frequencies. The inputs to the matrix supply ports comprise the baseband TV tuner signals TV1 to TV8 and baseband signals from other consumer devices. FIG. 1 shows six camera signal matrix inputs C1-C6 and five other device matrix inputs D1 to D5. All of the inputs are connected to the supply ports 90, from which control signals can be transmitted back to the devices that generate the signals. By way of example, a VHS 24 for recording signals, a DVD player 26, a user video recorder 28 a satellite receiver 30 (when 14 is an antenna) and a cable decoder 32 are shown in FIG. 1. Although not shown, the devices may also include audio systems. In the example of FIG. 1, these form part of the hub 10 although it will be apparent from the following that these devices may be connected to video or audio monitors located around the home if the user desires. Six cameras 34 are shown outside the hub 10. Most of the equipment in the hub is located within five meters of the switching matrix 22 for low losses and to provide a compact system that can be stored in a closet or small room. Most of the monitors are spaced more than five meters from the switching matrix and hub.

The inputs TV1 to TV8, C-1 to C6, D1 to D5 which are connected to the supply ports 90 of the switching matrix, and the outputs that are connected to the consumer ports P1 to P16, all provide signals that are not only used by a monitor, but provide signals passing in reverse from a consumer port to a supply port to control the various sources of video or audio signals.

It is possible for the eight TV outputs at 38 to be provided directly as inputs to the switching matrix 22. In that case, each TV tuner is allocated a particular supply port 90, and the switching matrix by default connects each TV tuner to a corresponding supply port. In that case, there should be the same number of supply ports 90 dedicated to the TV tuners, as the maximum number of TV tuners 12. However, for greater flexibility, FIG. 1 shows a system with more supply ports 90 for receiving the outputs of the TV tuners, than the number of TV tuners TV1-TV8. This allows the TV tuners to be allocated to one of a plurality of different supply ports 90. For this purpose, the hub has an array 36 of connectors S1 to S16. Each connector in the array can be connected to one of the TV tuners by a linking element 38. The linking element 38 may be manually positioned (and connected) to enable the system to be configured according to requirements. This enables a patch panel system to be implemented. Thus, in the example of FIG. 1, the user has decided that tuner TV1 should be provided to consumer port P2 in the lounge L, and this is achieved by manually inserting a linking element 38 between tuner TV1 and connector S2. This decision will be based, for example, on a position of furniture in the home and on possible problems with a tuner so that another tuner can be used. Similarly, the output of tuner TV2 is provided through switch 54 to consumer port P4 that connects to a video monitor in the main bedroom B1, and so on. The hub connections connect each TV tuner to a selected connector S1-S16 and connect each connector to a correspond supply port 90. In FIG. 1, twenty-seven supply ports are shown. The default setting of the switching matrix 22 is to couple the supply ports leading from connectors S1 to S16 respectively to the consumer ports P1 to P16. This makes it easier for a person to review the system and make any changes, since the connection of each supply port 90 to a consumer port P1 to P16 lies in the switching matrix 22 whose inside workings are generally not easily viewed. Each connector and supply port is marked with its number.

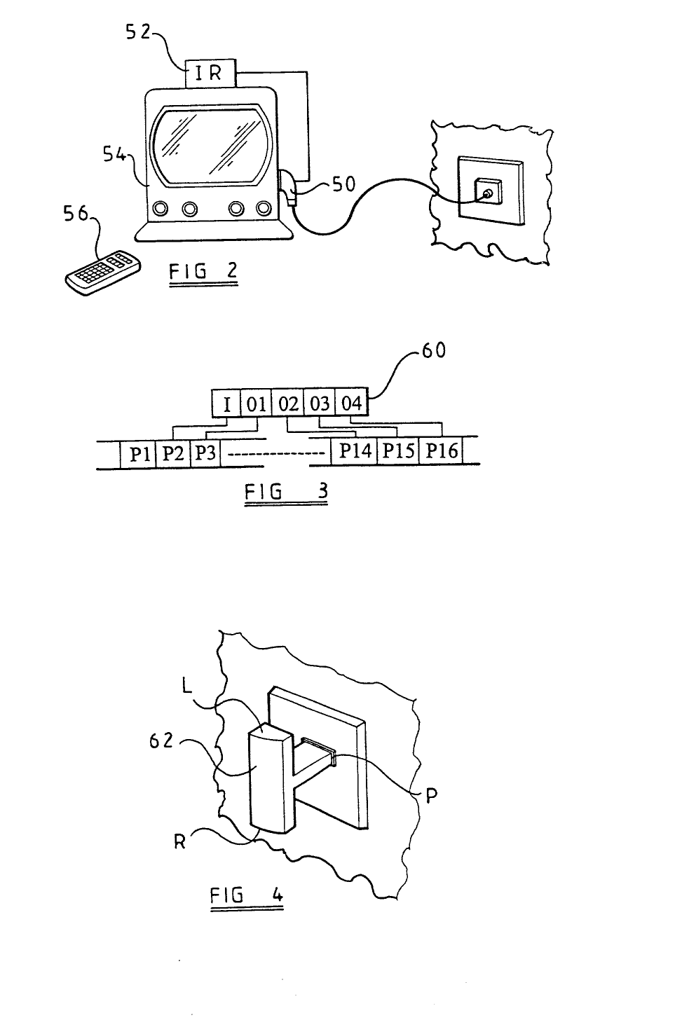

Each terminal 18 that is in use, includes a video monitor 54 (or audio, or data monitor or other device that uses the input signals) and is also provided with an infrared remote control sensor 54 that allows the viewer to select a channel (or a camera). As shown in FIG. 2, at a terminal that is in use, the audio (left and right) and the video twisted pair of signals from an RJ45 connector are provided to an AV socket 50, which connects to the TV set or monitor 54. If the TV 54 has a tuner (for receiving and demodulating a high frequency carrier signal) and a baseband input, the socket 50 is connected to the baseband input. This enables baseband signals to be provided to the TV 54 without lossy (and noisy) remodulation and demodulation to and from a high frequency carrier signal. The remote control signals are provided from a control 56 to a remote control sensor 52 for mounting on (or which is part of) the television 54. The signals from the sensor 52 are delivered over a twisted wire pair connected through a line to one of the ports P1-P16 (FIG. 1). The twisted pair for the remote signals carry duplex signals, and also carry the power to the remote control sensor 52.

The hub includes a processor 23 (FIG. 1) which receives all of the remote control signals provided along the line 22 from each terminal. The hub therefore detects all remote control choices made by the user and uses this information to control the switching matrix 22 (assuming that the matrix should be switched away from its original default configuration).

In one example, the user at the terminal 18 that is connected to the consumer port P1, selects a channel that is reserved for the video recorder 28, and the switching matrix will switch the output of connector D3 which is connected to one of the supply ports 90, to consumer port P1 and to the output line 23 at P1, which is associated with the input line 21 at P1 from which the video signal arrived. This overrides the default connection of TV1 to P1, to connect the output of D3 to P1. As mentioned above, each terminal 18 is provided with a remote control signal reader 54 which may be a standard IR detector. In order to provide IR signals to the detector, the twisted pair of cable leading to the terminal 110 is provided with an LED (light emitting diode) which is fixed adjacent to the standard detector of the terminal. Thus the IR signals are converted to electrical signals at the consumer ports P1-P16 and are reconverted to IR signals at the terminals 18.

The system connects the remote control signals delivered over lines 23 to the consumer ports P1-P16 so the signals received by the switching matrix are permanently routed simultaneously to all of the devices that supply signals, including remote control reader 16 of the tuners TV1-TV8, and similar remote control readers of the devices 24-32 and the cameras 34. A single remote control 54 for any device can be used in any room of the house. In a preferred arrangement, the switching matrix simply routes the remote control signal to all devices, and the device being controlled will recognize the signal whereas the other devices will not. Thus, for example, a video remote control can be used at the terminal 18 connected to consumer port P2 to control the video 28 in the hub.

Each video (or audio or data) generation device 24-32 has an allocated channel (or other remote control signal input) so the hub can connect the user to any desired equipment from any terminal 18. Essentially, the switching matrix function to override the normal connection of the TV tuner video and audio to the port.

As shown in FIG. 1, the switching matrix 22 is connected, through connectors C1-C6 and corresponding supply ports 90, to six security cameras 34. The switching matrix 22 enables camera images from any of the six cameras to be coupled to a selected one of the video monitors 52 in the system. For example, if a user should select a terminal 18 connected to consumer port P1, and switches the outputs of all six cameras (on connectors C1-C6) the switching matrix may switch the cameras to the monitor 52 at consumer port P1 so the camera outputs appear on the monitor in a cyclical manner, such as where the output of each camera is displayed for three seconds before the output of the next camera is displayed. The user can operate the control 54 to stop the cycling and constantly display the output of one of the six cameras.

Each camera may be provided with a motion and/or sound sensor. When such motion or sound is detected, an alarm icon may be provided on the monitor 18 which has requested such alert.

The cameras 34 may not need actual RJ44 ports, as they may be installed in one positioned and remaining fixed. However, the camera control and signals are relayed using the same cabling, and could be connected to identical ports as for the remainder of the system. This may be desired if a camera location is to be changed.

FIG. 3 shows an extension of the system to provide distributed audio. The extension may use the same groups of consumer ports P1-P16, or may use additional ports. In FIG. 3, the ports P1-P16 of the system can be connected to a further switching arrangement 60 for selectively coupling a first supply port at which audio is received from a consumer device, to multiple other consumer audio ports. For example, the signal at consumer port P2 is provided as an input I to the switching arrangement 60, and the four outputs O1 to O4 from the switching arrangement are connected to ports P3, P14, P15, and P16. In this way, a sound output can be provided to one supply port (at the location of an audio disc player, etc.) and the switching arrangement can route the audio signals to consumer ports to which speakers are connected. The switching arrangement 60 may be a manual device located at the hub, or at another suitable location, and enables the control of the distribution of audio. Each consumer port may have an independent volume control for the speaker signals, so that different volumes may be provided in different rooms.

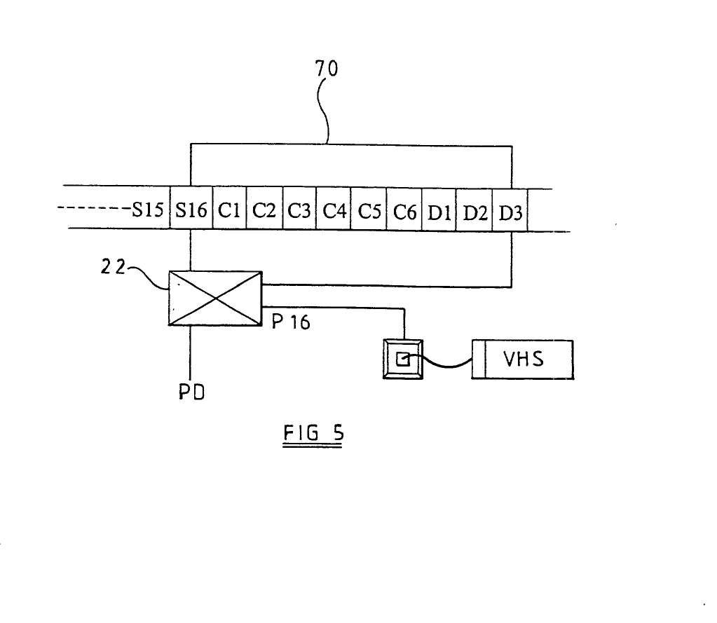

FIG. 4 shows a connector 62 for extracting the audio part from a consumer port P, which provides one twisted pair as a left speaker signal L and one twisted pair as a right speaker signal R.

In the example given above, the sources of video and sound are located in the hub 10. This has the advantage of short connections, which decrease noise and the amount of required amplification. However, the signal generating devices can be at any desired location. FIG. 5 shows a video recorder 28 in a room of the house and connected to consumer port P16 (to the line that carries control signals or to a duplex line that carries signals to and from the consumer port). The switching matrix 22 couples the video signal to a supply port leading to connector S16, and physical connections 70 within the hub connects the video signal to the switching matrix input D3. The signal is switched from D3 to the desired port PD by the switching matrix 22.

Numerous variations to the system will be apparent to those skilled in the art. The number of ports, the number of signal-generating devices including TV tuners and cameras supported by the system, are all by way of example only. The invention enables multiple devices to be connected together by use of low cost cabling (twisted wire pairs instead of coaxial cables) with a high degree of flexibility. The transparency of the system to IR control signals allows existing remote control devices to be used. Each device in the hub enables the remote control signals to be regenerated (for example, an LED) and directed to the IR detectors. Multiple remote controls may be combined to a single programable remote control device to enable control of a pool of devices. The devices in the hub, served to supply baseband signals to the switching matrix, and enable all cabling to be accomplished by twisted pair cabling.

The invention can be implemented using well known equipment. Implementation is with a baseband switching matrix and a processor which receives inputs from remote control device signals. The system can be supplemented with various designs of user interface, with menus for defining the system set up and operation.

Thus, the invention provides an entertainment center system that allows each person viewing one of many video monitors scattered throughout a home, to select one of numerous channels supplied by a carrier signal source such as a cable video system, in the same manner as a person viewing a television set connected directly to the cable system can select a channel. However, the system also allows each viewer to select a different source of video signals, such as the output from a DVD player, a camera, or a demodulated channel from another source such as a satellite dish or an antenna, or to even select a different TV tuner that receives the same carrier signal as the TV tuner whose output was previously viewed. This is accomplished by a hub in which a plurality of TV tuners are located, which each demodulates the output of one (or more) carrier signals and other sources, and which also includes a switching matrix. The switching matrix has a plurality of supply ports that are connected to the sources of the signals that may be desired by the person at a monitor in a room, which are primarily video signals but which also include audio signals and even data signals. The switching matrix also has a plurality of consumer ports which are connected to the terminals in the different rooms. Each port can receive and deliver a signal, to allow not only video and audio signals to be transmitted, but to allow channel-selecting control signals and other control signals to be transmitted in the opposite direction to the source, such as to the TV tuner to change the channel. Wires can be used that pass signals in opposite direction along with a duplex circuit that routes signals traveling in different direction to different circuits, although applicant generally prefers to use separate wires.

Although particular embodiments of the invention have been described and illustrated herein, it is recognized that modifications and variations may readily occur to those skilled in the art, and consequently, it is intended that the claims be interpreted to cover such modifications and equivalents.

What is claimed is:

1. A home entertainment system, comprising:
a hub having a plurality of TV tuners for each demodulating a video carrier signal that is modulated with a plurality of video channels, each TV tuner having an output that carries a baseband signal representing one of the video channels, and each TV tuner having an input for receiving control signals to change the channel;
a plurality of terminals that each includes a video monitor for displaying a video image and a controller for generating control signals;
a switching matrix that has multiple supply ports, each of a plurality of said supply ports connected to an output of one of said TV tuners, and having multiple consumer ports each connected to the video monitor and controller of a terminal.

2. The home entertainment system described in claim 1, wherein:
each of said TV tuners includes a stereo sound decoder.

3. The home entertainment system dec in claim 1 including:
a multiplicity of twisted wire pair cables, a plurality of said twisted wire pair cables extending between said TV tuners and said supply ports and a plurality of twisted wire pair cables extending between said consumer ports and said terminals.

4. The home entertainment system backbone described in claim 3, wherein:
each of said twisted wire pair cables that connects to a terminal includes four twisted wire pairs.

5. The home entertainment system described in claim 4, wherein:
one of twisted wire pairs is allocated to remote control signaling, one twisted wire pair is allocated to one channel of audio, one twisted wire pair is allocated to another channel of audio and one twisted wire pair is allocated to video data.

6. The home entertainment system described in claim 1 including:
a plurality of linking elements that carries signals;
said hub has an array of connectors, each connector in the array being connectable to a TV tuner by one of said linking elements and each connector being connectable to a selected one of the supply ports of the switching matrix by another linking element, whereby each TV tuner can be associated with a selected consumer port using the linking elements.

7. The home entertainment system described in claim 1 including:
at least one of video camera connected to one of said supply ports.

8. The home entertainment system described in claim 7, wherein:
said camera has a motion detector and generates an alarm signal when it detects motion;
said hub comprises means for detecting an alarm signal from the camera output, and wherein the switching matrix is controllable in response to the alarm signal to interrupt at least a portion of the output of a selected TV tuner and deliver camera signals in their place.

9. The home entertainment system described in claim 1, wherein:
said switching arrangement is constructed to selectively couple a first supply port at which audio is received from a consumer device to selected multiple consumer ports, and including a plurality of loudspeakers connected to said selected multiple consumer ports.

10. An entertainment center system that includes a plurality of TV tuner video devices that each demodulate at least one high frequency carrier signal to generate each of a plurality of corresponding baseband signals, a plurality of generating video devices that each generates baseband signals, and a plurality of video monitors that are isolated from one another, comprising:
a switching matrix that has a default setting wherein said switching matrix connects each of a plurality of the baseband signals of said video devices to each of a selected one of said video monitors;
a plurality of controls for use at each of said video monitors, which enables a person viewing a particular video monitor to control the switching matrix to connect the baseband signal of a different one of said video devices to said particular video monitor;
at least one of said generating video devices is a video camera that generates a view of an area, and said switching matrix is constructed to switch one of its outputs that is delivered to one of said video monitors, to display the output of one of said TV tuner devices or the output of said camera.

11. The system described in claim 1 including:
a motion detector that detects motion in the view of the video camera;
an alert device that generates an alert signal indicating motion largely in the view of the video camera;
said switching matrix connects said alert signal to a selected one of said video monitors to produce an alert at the video monitor.

12. The entertainment center described in claim 10 wherein:
said TV tuner video devices and said switching matrix are all located in the same particular room of a home;
said video camera is located outside of said particular room.

13. The system described in claim 10 wherein:
each of said TV tuner video devices is operable to generate a baseband video signal representing one of multiple video channels, and including a channel changer associated with each TV tuner video device for generating a signal to operate the TV tuner video device to demodulate another of said multiple video channels when the corresponding monitor is connected to one of said TV tuner video devices, said switching matrix including a plurality of controls each responsive to one of said channel changer at a video monitor for operating a corresponding TV tuner video device to change the video channel that is generated.

14. The system described in claim 10 wherein:
said switching matrix has multiple signal inputs and multiple signal outputs that are all baseband signals, and including multiple video signal cables that each connects said switching matrix to one of said monitors and with only baseband signals outputted from said switching matrix and carried by said video signal cables of said monitors.
